(19) United States
(12) Patent Application Publication
(10) Pub. No.: US 2015/0120788 A1
(43) Pub. Date: Apr. 30, 2015

(54) CLASSIFICATION OF HASHTAGS IN MICRO-BLOGS

(71) Applicant: Xerox Corporation, Norwalk, CT (US)

(72) Inventors: Caroline Brun, Grenoble (FR); Claude C. Roux, Grenoble (FR)

(73) Assignee: Xerox Corporation, Norwalk, CT (US)

(21) Appl. No.: 14/064,327

(22) Filed: Oct. 28, 2013

(51) Int. Cl. G06F 17/30; G06F 17/27

(52) U.S. Cl. CPC G06F 17/30312; G06F 17/30401; G06F 17/277
USPC 707/812

(57) ABSTRACT

A method for processing micro-blogs includes, for each of a set of hashtags extracted from a collection of micro-blogs, decomposing the hashtag to generate a sequence of words and natural language processing the decomposed hashtag with rules configured for identifying syntactic dependencies and targets, such as proper names, in the dependencies. Opinion detection rules are applied to the detected dependencies which are configured for extracting opinion information from decomposed hashtags, such as a polarity based on presence of a polar term in a dependency. At least some of the hashtags in the set of hashtags are stored in a hashtag lexicon, the stored hashtags being associated with the extracted opinion information. A computer processor may perform the decomposing, natural language processing, applying opinion detection rules, and storing of the hashtags.

### BACKGROUND

The exemplary embodiment relates to opinion mining and finds particular application in connection with classification of micro-blogs, also referred to as short posts, which are published on social networking sites.

Opinion mining often involves natural language processing, computational linguistics, and text mining. The object is to determine the attitude of a speaker or a writer with respect to some topic, from text written or spoken in natural language. Opinion mining has many applications related to business analytics. For example, companies often seek to detect customers' opinions on their products. The target corpora of such opinion mining applications are often social networks, blogs, and e-forums that are a fertile source of topics and opinions.

Micro-blogging services allow users to communicate via character-limited messages. The Twitter™ service, for example, is an online social networking service and micro-blogging service that enables its users to post and read text-based messages of up to 140 characters, known as Tweets™. Users can group posts together by type through the use of hashtags. These are words or short phrases prefixed with a designated hash symbol, commonly the “#” sign. A hashtag is a form of metadata tag. Hashtags can be used to mark individual messages as relevant to a particular group or to mark individual messages as belonging to a particular type or “channel.” For example “#snowpocalypse” is a hashtag often used when blizzards strike; “#w2e” indicates that the tweet is related to the Web 2.0 Expo technology conference, etc.

Analysis of the frequency of use of certain hashtags could provide an indication of topics that are currently of interest. However, hashtags are not amenable to conventional opinion mining methods and they have not been used as a meaningful source of opinions on a given topic.

### INCORPORATION BY REFERENCE

The following references, the disclosures of which are incorporated herein by references in their entireties, are mentioned:

U.S. application Ser. No. 13/600,329, filed Aug. 31, 2012, entitled LEARNING OPINION-RELATED PATTERNS FOR CONTEXTUAL AND DOMAIN-DEPENDENT OPINION DETECTION, by Anna Stavrianou, et al.

U.S. Pub. No. 20100082331, published Apr. 1, 2010, entitled SEMANTICALLY-DRIVEN EXTRACTION OF RELATIONS BETWEEN NAMED ENTITIES, by Caroline Brun, et al.

U.S. Pub. No. 20120245924, published Sep. 27, 2012, entitled CUSTOMER REVIEW AUTHORING ASSISTANT, by Caroline Brun.

U.S. Pub. No. 20120245923, published Sep. 27, 2012, entitled CORPUS-BASED SYSTEM AND METHOD FOR ACQUIRING POLAR ADJECTIVES, by Caroline Brun.

U.S. Pub. No. 20130218914, published Aug. 22, 2013, entitled SYSTEM AND METHOD FOR PROVIDING RECOMMENDATIONS BASED ON INFORMATION EXTRACTED FROM REVIEWERS' COMMENTS, by Anna Stavrianou, et al.

U.S. Pub. No. 20130096909, published Apr. 18, 2013, entitled SYSTEM AND METHOD FOR SUGGESTION MINING, by Caroline Brun.

U.S. Pub. No. 20130080152, published Mar. 28, 2013, entitled LINGUISTICALLY-ADAPTED STRUCTURAL QUERY ANNOTATION, by Caroline Brun, et al.

U.S. Pub. No. 20130191478, published Jul. 25, 2013, entitled OPINION FORMING USING SOCIAL NETWORKING, by Michael Ure.

U.S. Pub. No. 20130159219, published Jun. 20, 2013, entitled PREDICTING THE LIKELIHOOD OF DIGITAL COMMUNICATION RESPONSES, by Patrick Pantel, et al.

U.S. Pat. No. 7,058,567, issued Jun. 6, 2006, entitled NATURAL LANGUAGE PARSER, by Salah Aït-Mokhtar, et al.

Salah Aït-Mokthar, Jean-Pierre Chanod, and Claude Roux, “Robustness beyond Shallowness: Incremental Dependency Parsing,” Special Issue of NLE Journal (2002).

### BRIEF DESCRIPTION

In accordance with one aspect of the exemplary embodiment, a method for processing micro-blogs includes, for each of a set of hashtags extracted from a collection of micro-blogs, decomposing the hashtag to generate a sequence of words, and natural language processing the decomposed hashtag with rules configured for identifying opinion dependencies linking targets with polar terms. Opinion detection rules are applied to the opinion dependencies identified by the natural language processing, the opinion detection rules being configured for extracting opinion information from decomposed hashtags. At least some of the hashtags in the set of hashtags are stored in a hashtag lexicon, the stored hashtags being associated with the extracted opinion information.

At least one of the decomposing, natural language processing, applying opinion detection rules and storing of the hashtags may be performed with a computer processor.

In accordance with another aspect of the exemplary embodiment, a micro-blog processing system includes an extraction component configured for extracting hashtags from micro-blogs. A decomposition component decomposes an extracted hashtag to generate a sequence of words. A parser natural language processes the decomposed hashtag with rules configured for identifying opinion dependencies linking targets with polar terms in the decomposed hashtag. A sentiment analysis component applies opinion detection rules to the opinion dependencies identified by the natural language processing to extract and output opinion information for the hashtag. A processor implements the extraction component, decomposition component, sentiment analysis component, and hashtag opinion extraction component.

In accordance with another aspect of the exemplary embodiment, an opinion extraction system includes memory which stores a lexicon of hashtags in which at least some of the hashtags are each associated with opinion information comprising a polarity and a target of the opinion, the opinion information having been automatically extracted by decomposing and natural language processing the hashtag. An opinion detection component is configured for receiving a query related to a topic and for aggregating opinion information of the hashtags in the lexicon for which the respective target is relevant to the topic. A processor implements the opinion detection component.

### BRIEF DESCRIPTION OF THE DRAWINGS

FIG. 1 is a functional block diagram of a system for processing micro-blogs in accordance with one exemplary embodiment;

FIG. 2 shows an example micro-blog for illustration purposes;

FIG. 3 is a flow chart illustrating a method for processing micro-blogs in accordance with other exemplary embodiment;

FIG. 4 illustrates decomposition of hashtags in the method of FIG. 3, in accordance with one exemplary embodiment; and

FIG. 5 illustrates natural language processing of the decomposed hashtags in the method of FIG. 3, in accordance with one exemplary embodiment.

### DETAILED DESCRIPTION

Aspects of the exemplary embodiment relate to a system and method for extracting opinions from micro-blogs, such as Tweets™. The exemplary system and method make use of the information carried by hashtags, in order to improve classification of micro-blogs regarding opinions. The exemplary method decomposes each hashtag into a sequence of constituent words, analyzes the sequences of words in order to extract a sentiment polarity and, when present, a target.

Syntactic dependencies are grammatical relations linking two or more syntactic units (i.e., words or phrases) in a sentence. Syntactic dependencies are of a predefined type, and may include standard grammatical functions, such as Subject (which extracts the syntactic unit, e.g., noun, that serves the subject of a sentence or clause and the verb of which it is the subject), Object (which extracts the syntactic unit, e.g., noun, that serves as the object of a sentence or clause and the verb of which it is the object), Verbal Modifier (which extracts the syntactic unit that is a verb of a sentence or clause and an adjective which modifies it), Nominal Modifier (which extracts the syntactic unit that is a noun of a sentence or clause and noun which modifies it), Attribute (which extracts the syntactic unit that is a noun of a sentence or clause and an adjective which modifies it), etc., all of which may be extracted by a general dependency parser.

A target of an opinion (which may be tagged as OPINION_TARGET) is a term which is in an opinion dependency with a polar term (tagged POLAR_TERM). The target of the opinion dependency can be a noun, a predicate, or any other part of speech for which dependencies with polar terms can be extracted.

An opinion dependency is a specific type of syntactic dependency of the form: OPINION[POLARITY](POLAR_TERM, OPINION_TARGET), where OPINION is the name of the dependency, POLARITY indicates whether the opinion is favorable (positive) or not (negative), POLAR_TERM is the opinionated word or expression carrying the polarity of the expression, and OPINION_TARGET is the target of the opinion. Opinion dependencies can be built on the top of syntactic dependencies by combining lexical information about polar terms and syntactic dependencies. Opinion relations are extracted, in the exemplary embodiment, when a syntactic dependency is found linking an OPINION_TARGET and a POLAR_TERM. In some cases, the opinion relation is one in which the OPINION_TARGET is restricted to being one of a set of defined topics, or can be any noun, or unknown, in some instances.

A “topic” can be a proper name or other predefined noun or noun phrase or the like which is of interest and for which opinion dependencies with polar terms can be extracted.

This information can be stored in a hashtag lexicon and/or utilized in an opinion detection component (or a separate opinion detection system).

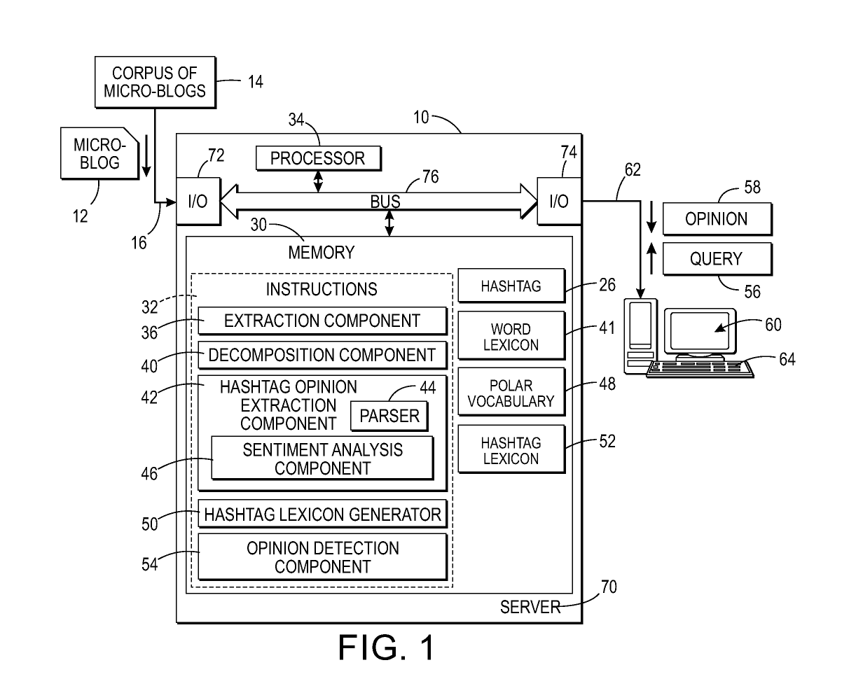

FIG. 1 illustrates an exemplary computer-implemented system 10 for processing of micro-blogs. The system receives as input a micro-blog 12 to be processed. In one embodiment, the system 10 has access to a corpus 14 containing a set of micro-blogs 12 which is input to the system for processing. The corpus 14 of micro-blogs may be stored in non-transitory memory of a remote micro-blogging service which is accessible to the system 10 via a wired or wireless connection 16, such as the Internet. The corpus may be limited to a predefined time interval, such as micro-blogs posted in the last hour(s), day(s), week(s), or the like.

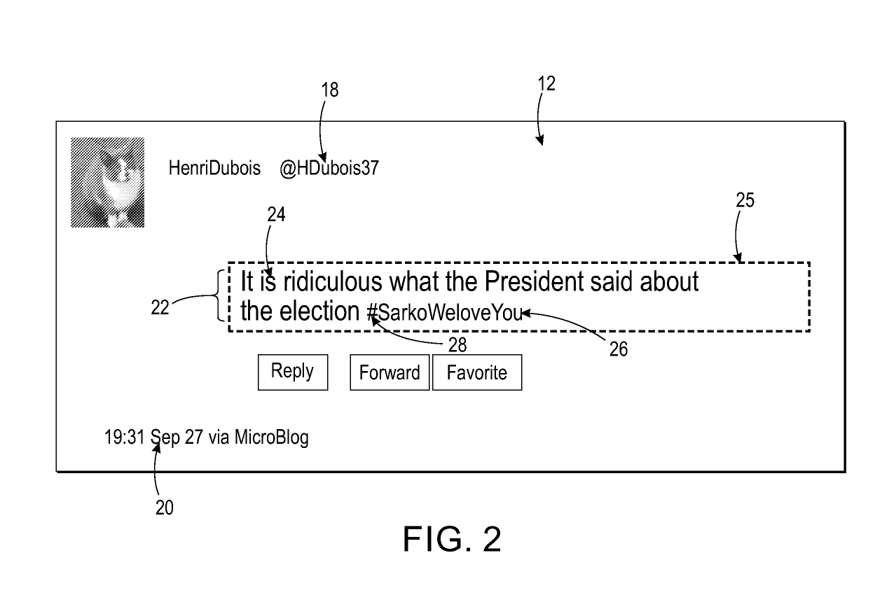

With reference also to FIG. 2, each micro-blog 12 may include an identifier 18 of the person or organization posting the micro-blog. The identifier often starts with an identifier symbol, such as the @ symbol. The micro-blog may also include a date and/or time 20 on which the micro-blog was made publicly available by a micro-blogging service. The content 22 of the micro-blog generally includes text 24 in a natural language such as English. The content 22 may be associated with a predefined text content field 25 and tagged as such. Some or all of the received micro-blogs include one or more hashtags 26 (some, although not all, of the micro-blogs may include no hashtags). The hashtag(s) 26 may be embedded in the text content 24 of the micro-blog and may be identified by a predefined hashtag symbol 28, such as the # symbol, e.g., as a prefix.

As illustrated in FIG. 1, the micro-blog processing system 10 includes memory 30, which stores instructions 32 for performing the exemplary method, and a processor 34 in communication with the memory 30 for executing the instructions. The instructions 32 include an extraction component 36 which identifies and extracts hashtags 26 in the input micro-blogs 12.

A decomposition component 40 decomposes each identified hashtag 26 into a sequence of constituent words. At least some of the decomposed hashtags include at least two identified words. Fewer than all of the decomposed hashtags include only one word. The decomposition component 40 may utilize a specialized word lexicon 41 in identifying an optimal split of the hashtag, which includes identifying words recognized as topics (e.g., all proper nouns or those on a predefined list of topics) in the text 24 within a large corpus 14 of micro-blogs. The word lexicon 41 includes a list of single words in the language of interest and may be supplemented with proper names (e.g., names of people, organizations, places, events, titles of works such as books, films, etc.), and known abbreviations, nicknames, etc., of topics of interest.

A hashtag opinion extraction component 42 determines whether the decomposed hashtag conveys an opinion based on the sequence of constituent words and if so, outputs semantic information which includes a polarity of the opinion, e.g., as positive or negative and, if present, a target of the opinion. The illustrated opinion extraction component 42 includes a syntactic parser 44 and a sentiment analysis component 46. The parser 44 processes the sequence of words to assign respective parts of speech (POS) to the words. The parser may tag some of the words with topics, e.g., which identify them as named entities. The parser 44 also extracts dependency relations between the words (such as subject (SUBJ) and object (OBJ) relationships). In this way, some of the identified dependency relations can include words or phrases which have been tagged as topics that are in a dependency with another word or phrase, in particular, with terms that are in a polar vocabulary 48.

The sentiment analysis component 46 assigns a polarity to the hashtag 26. In particular, the sentiment analysis component 46 accesses the polar vocabulary 48 and applies a set of sentiment extraction rules, which may be written on top of the parser rules. The polar vocabulary 48 includes a set of polar terms (words and optionally short phrases), each term being associated with a respective polarity. The polarity of each term in the polar vocabulary 48 may be selected from two values corresponding to positive and negative or may be selected from more than two values or be a scalar value which further quantifies the polarity. Some of the rules applied by the sentiment analysis component 46 may be based solely on the polarity of one or more words in the sequence which is/are identified as being in the polar vocabulary 48. Additionally, at least some of the applied rules are based not only on the presence of the words in the polar vocabulary but also on specified dependencies which include these words.

A lexicon generator 50 generates a hashtag lexicon 52 which associates each processed hashtag 26 with its respective semantic information, where available, which may include an overall polarity of the hashtag, based on the rule(s) which fired on the sequence of words, and the topic referred to in the hashtag, if one has been identified. A frequency of occurrence of the hashtag in the corpus may also be identified (e.g., total number of occurrences or proportion of all identified hashtags in the corpus, or the like). The frequency of occurrence may be stored in the lexicon 52 or otherwise linked to the respective lexicon terms.

As will be appreciated while three dictionary-type resources 41, 48, 52 are illustrated, two or more of these may be combined into a single resource, with appropriate indexing. Each of the resources 41, 48, 52 may be stored in the form of a list, table, database, or other suitable data structure.

An opinion detection component 54 (which may be in the form of a separate opinion detection system with access to the lexicon 52) receives as input a query 56, which may include a specified topic, and outputs an opinion 58 on the topic based on the polarity of the hashtags 26 which are stored in the lexicon that refer to that topic. The exemplary opinion detection component is configured for aggregating opinion information of the hashtags in the lexicon for which the respective target is relevant to the topic. The opinion may indicate how many (or what proportion) of the relevant hashtags are positive and how many are negative or other information based thereon.

In another embodiment, the opinion detection component 54 may output an opinion on a topic based not only on the hashtags 26 but also on the textual content 24 (i.e., the content other than the hashtags) of the micro-blogs 12 that refer to the topic. The opinions expressed in the textual content may be extracted in a similar manner to the processing of the decomposed hashtags. The overall opinion on a topic may thus be based on the hashtag(s) (if any) extracted from each micro-blog as well as on opinion relations extracted from the textual content 24.

In another embodiment, the opinion detection component 54 may take as input a single micro-blog as the query 56 and output an opinion based on the hashtag(s) 26 and optionally also on the textual content 24 of the micro-blog.

The system 10 may be communicatively connected with one or more client devices 60, e.g., via a wired or wireless link 62, such as a local area network or a wide area network, such as the Internet. The client device may include a user input device 64 such as a keyboard, keypad, cursor control device, touch screen, or combination thereof for creating the user query 56 which is fed, in appropriate query language, to the opinion detection component 54. The opinion 58 on the query topic generated by the opinion detection component 54 by identifying the opinions of the hashtags that refer to the topic, e.g., by accessing the lexicon 52, may be returned to the client device, or to another computing device.

The system 10 may include one or more computing devices, such as a PC, such as a desktop, a laptop, palmtop computer, portable digital assistant (PDA), server computer, cellular telephone, tablet computer, pager, combination thereof, or other computing device capable of executing instructions for performing the exemplary method. While FIG. 1 shows the components of the system being resident on a server computer 70, it is to be appreciated that some or all of the component may be resident on the client device or on other communicatively connected computing devices.

Computer system 10 also includes one or more network interfaces 72, 74 for communicating with external devices. The various hardware components 30, 34, 72, 74 of the computer 10 may all be communicatively connected by a data/control bus 76.

The memory 30 may represent any type of non-transitory computer readable medium such as random access memory (RAM), read only memory (ROM), magnetic disk or tape, optical disk, flash memory, or holographic memory. In one embodiment, the memory 30 comprises a combination of random access memory and read only memory. In some embodiments, the processor 34 and memory 30 may be combined in a single chip. Memory 30 stores instructions for performing the exemplary method as well as the processed data 52.

The network interface 72, 74 allows the computer to communicate with other devices via a computer network, such as a local area network (LAN) or wide area network (WAN), or the internet, and may comprise a modulator/demodulator (MODEM) a router, a cable, and and/or Ethernet port.

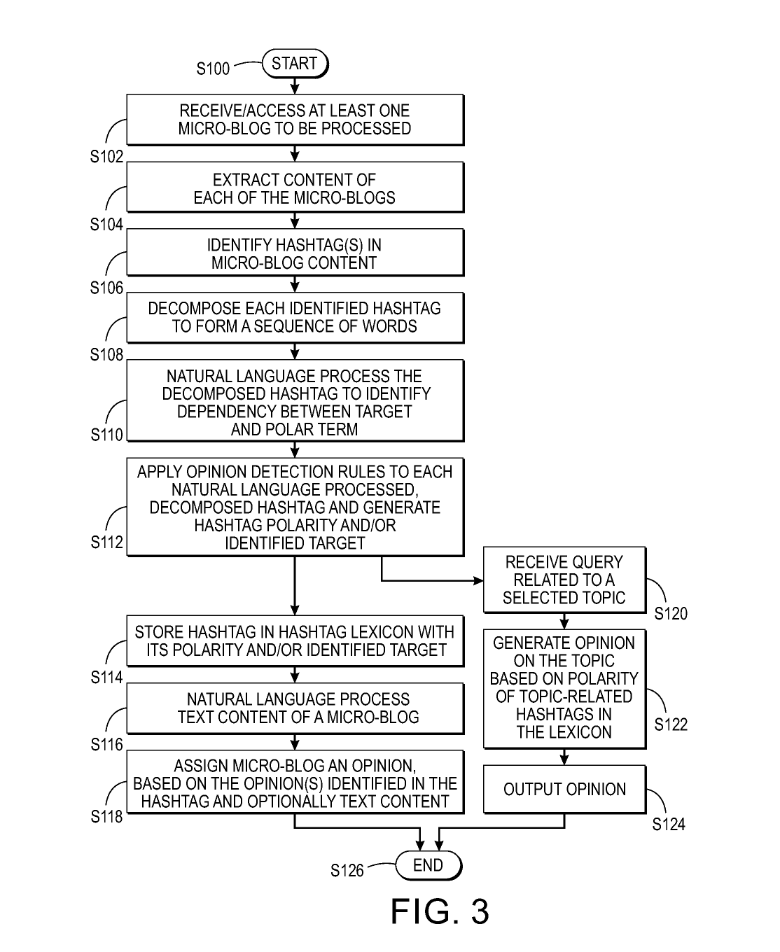

The digital processor 34 can be variously embodied, such as by a single-core processor, a dual-core processor (or more generally by a multiple-core processor), a digital processor and cooperating math coprocessor, a digital controller, or the like. The digital processor 34, in addition to controlling the operation of the computer 70, executes instructions stored in memory 30 for performing the method outlined in FIG. 3.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 1 is a high level functional block diagram of only a portion of the components which are incorporated into a computer system 10. Since the configuration and operation of programmable computers are well known, they will not be described further.

FIG. 3 illustrates a method for processing micro-blogs which may be performed with the system of FIG. 1. The method begins at S100.

At S102, a micro-blog or a corpus 14 of multiple micro-blogs is accessed and/or received.

At S104, the content 22 of each of the micro-blogs 12 is extracted, e.g., by the extraction component 36, if this has not already been performed.

At S106, hashtags 26, if any, are identified in each micro-blog 12, by the extraction component 36.

At S108, the identified hashtag(s) are decomposed into a sequence of words, by the decomposition component 40.

At S110, the sequence of words is natural language processed, by the parser 44, to identify opinion dependencies which involve a polar term and its target.

At S112, opinion detection rules are applied by the sentiment analysis component 46 to the natural language processed sequence, and an overall opinion of the hashtag is assigned, based on the applied rules which fire on the processed sequence.

At S114, the processed hashtag may be stored in the hashtag lexicon 52, together with its associated opinion, and extracted target(s). In some embodiments, only those hashtags which have an identified polarity may be stored in the lexicon. In other embodiments, hashtags where an opinion is not identified are classed as neutral. Before adding the hashtags to the lexicon, provision may be made for manual validation to be performed, e.g., to assess whether the automated decomposition (S108) was reasonable.

At S116, the text content 24 of the micro-blog or of a new micro-blog may be processed in a similar manner to the hashtag, i.e., natural language processed by the parser 44 and opinion identified by the sentiment analysis component 46. In this embodiment, the hashtags present in the micro-blog may each be treated as a noun and the opinion information associated with the hashtag in the lexicon (if any) is used to identify an opinion for the micro-blog as a whole.

At S118, the micro-blog as a whole may be assigned an opinion, based on the opinion(s) identified in the hashtag and optionally also the text content.

At S120, a query 66 may be received for a given topic, such as a proper name, e.g., a person, event, object, or the like. The query may also specify a time frame, such as the last two days.

At S122 an opinion 68 on the topic is automatically generated, by the opinion detection component 54, by accessing the lexicon 52, i.e., based on the processed hashtags which are indexed as referring to that topic, constrained by the query time frame, if any. The opinion 68 may also take into account the number of occurrences of each hashtag and/or the opinions extracted from the text content 24.

At S124, the opinion 68 may be output from the system, e.g., to the client device, or may be further processed by the system. As will be appreciated, the opinion detection component may provide opinions in different forms using additional information.

The method ends at S126.

The method illustrated in FIG. 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 18, (for example, an internal hard drive of RAM), or may be separate (for example, an external hard drive operatively connected with the computer 18), or may be separate and accessed via a digital data network such as a local area network (LAN) or the Internet (for example, as a redundant array of inexpensive of independent disks (RAID) or other network server storage that is indirectly accessed by the computer 18, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the method for processing hashtags to identify opinion-related information carried by them. As will be appreciated, while the steps of the method may all be computer implemented, in some embodiments one or more of the steps may be at least partially performed manually.

Further details of the system and method will now be described.

### Extraction of Micro-Blog Content (S104)

In general, this may include extraction of all the text content 22 within a text content field 25 of the micro-blog. If there is no designated text content field, all the text (as recognizable characters within a predefined alphabet) may be extracted, using OCR processing or other character recognition methods.

### Extraction of Hashtags (S106)

Due to their simple representation, a character string without any white spaces that starts with a “#” character is recognized in a string of characters as a hashtag. The hashtag can also be used to unambiguously index the message that contains it.

For example, given the following example message:
Peter Smith is a great country music singer. #Ihatecountrymusic, the system extracts Ihatecountrymusic as a hashtag.

The hashtags can include a sequence of two or more characters, such as letters, numbers, punctuation, (in some cases) and the like.

### Hashtag Decomposition (S108)

Decomposition includes tokenizing the hashtag into a coherent sequence of words.

Various methods exist for reconstructing the inner structure of a non-spaced string. Koehn at al. have proposed different methods for decomposing German nouns, such as first splitting the string into potential roots, then measuring their frequency against a corpus or a dictionary. Then each set of roots is evaluated according to these frequencies, with a geometric mean score, to find the most appropriate split. For example, to split the German word aktionsplan, three possible splits are identified:

action(960)-plan(710)→825.6

aktions(5)-plan(710)→59.6

akt(224)-ion(1)-plan(710)→54.2

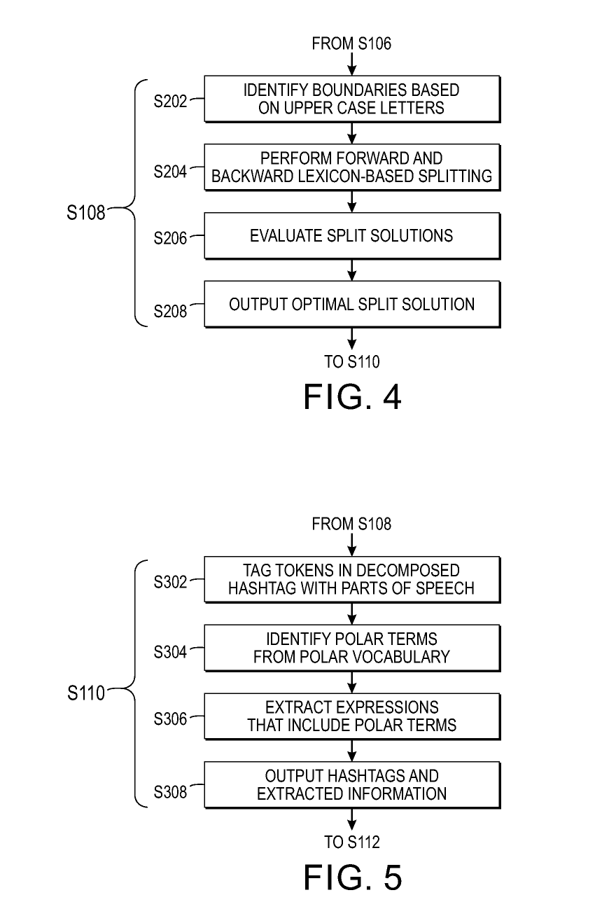

While such a method may be used in the exemplary method, the method shown in FIG. 4 has been found to be more suited to decomposition of hashtags, which are more likely to be short phrases or sentences. The words generated by a split are compared against the word lexicon 41. However, the method has been adapted to deal with a certain level of ambiguity when splitting these phrases, especially when these words are proper names.

At S202 the hashtag is searched for upper case letters as word boundary identifiers. An evaluation of hashtags in short messages has shown that people use different methods to build up these compounds. In many cases, they use uppercase letters to highlight the word boundaries. In the simple case of #IhateCountryMusic, for example, the method simply detects the uppercase letters and splits the hashtag before each to give the sequence I Hate Country Music.

However, such cases are not numerous enough to identify the proper splitting in the general case. For example, the uppercase may be the start of a proper name, while the rest of the string is all in lowercase as in #IlikeJanescake.

In the exemplary method therefore, the upper case detection is combined with lexicon-based splitting (S204). For example, the string is traversed twice: from head to tail, then backwards. The word lexicon 41 is composed of different sorts of words including common words and proper nouns (such as named entities, which may be tagged as topics), which have been detected in the corpus 14.

In particular, the character string 26 is first traversed from head to tail (i.e., in normal reading order), starting with the first character, concatenating letters into words. The exemplary method looks for the longest contiguous sequence of characters that is found in the word lexicon 41. After each new character is added, the word lexicon may be checked to determine if the new string is a word in the word lexicon. When this is the case, the word may be stored in a temporary buffer and the next character is added to the string. A longest match method is used, which means that the method attempts to produce the longest valid string before pushing it into a more permanent buffer. For example, in #Ihatecountrymusic, after identifying I and hate, the decomposition component 40 may identify count as being a word, but since it continues to look for the longest match, it will keep on adding new letters until it reaches the word “country.” The algorithm is thus quite greedy. However it ensures a better recognition rate than a system that stops every time it finds a match. The method continues after each split until no further characters remain to be processed, i.e., the end of the character string 26 or when an unrecognizable word is reached.

Once the longest word in the word lexicon 41 has been identified, the decomposition component 40 starts to build the next word, starting with the next character in the sequence 26 (m in the illustrated example). The method continues until there are no characters left in the sequence and outputs a split solution which includes a sequence of tokens identified as words. In the event that the sequence 26 comes across an unrecognized sequence of characters, these are simply stored as an unrecognized word. For example in the sequence #Ihate!$%̂#music, the system stores !$%̂#music as an unrecognized word in the split solution.

This process is repeated, but backward from tail to head (i.e., in reverse reading order). It has been found that in about 20% of the cases, the split produced is different.

As will be appreciated, when upper case letters are found within the sequence 26, at S202, these may be considered in generating the split at S204. A split may also be generated which ignores the upper casing.

At S206, once all the split solutions have been built, they are evaluated to identify an optimal split solution. This may include counting the number of valid words in each split solution that are found in the word lexicon. The set with the highest number is then identified as the optimal split solution. In other methods, frequency of occurrence of the words in a corpus, such as corpus 14 and/or other features may also be considered in identifying an optimal split solution.

At S208, the optimal split solution is output and/or stored in computer memory. The method continues to S110.

### Natural Language Processing of the Decomposed Hashtag (S110)

The decomposed hashtag may be processed by the linguistic parser 44 of the system 10, which takes as input the tokenized output of the decomposition component 40 which may also provide tags from the word lexicon 41, which identify parts of speech of each of the recognized words (some of which may have more than one part of speech). FIG. 5 illustrates this step in one example embodiment.

At S302, the parser 44 assigns candidate parts of speech (POS), such as noun, verb, adjective, adverb, to each word, which may be refined to a single part of speech per word as ambiguities are resolved. Proper nouns and Named Entities may also be identified and tagged as nouns. Further analysis by the parser 44 (called chunking) optionally allows words to be grouped around a head to form noun phrases, adjectival phrases, and the like.

At S304, polar terms, such as polar predicates and adjectives, are identified using the polar vocabulary 48. The parser includes a normalization component that matches words, such as verbs to their lemmatized (root) form, which in the case of verbs may be the infinitive form and in the case of nicknames, the stored name of the person. For example, the parser compares the words and phrases in the decomposed hashtag that have been tagged with the part of speech ADJ (adjective) or VERB, with the terms in the polar vocabulary 48, and any terms that are found in the polar vocabulary are tagged as polar terms and assigned a polarity based on the assigned polarity of the respective term in the polar vocabulary 48. For example hate and ugly may be assigned a negative polarity and love and beautiful a positive polarity.

Methods for generating a polar vocabulary 48 which may be used herein are described in above-mentioned U.S. Pub. No. 20120245923, incorporated herein by reference.

Some words and phrases however may be considered as polar only in certain contexts, which may be identified using specific opinion detection patterns. See, for example, above mentioned U.S. application Ser. No. 13/600,329, for a discussion of the generation of such patterns. For example, the word vote may be treated as positive in polarity if it is in a syntactic dependency with a named entity of the type Person or Organization, otherwise it has no polarity.

At S306, expressions of a set of predetermined type(s) may be extracted, such as NOUN-ADJECTIVE and NOUN-PREDICATE expressions, and normalized to form patterns. In particular, syntactic analysis by the parser extracts syntactic relationships (dependencies) between POS-labeled terms (words and/or phrases). Syntactic relations are thus found between terms which need not be consecutive and which can be spaced by one or more intervening words within the same phrase or sentence. Coreference resolution (anaphoric and/or cataphoric) can be used to associate pronouns, such as he, she, it and they with a respective noun, based on analysis of surrounding text, which need not necessarily be in the same sentence. Words of negation which are in a syntactic relation with the adjective in the expression may also be considered and used to modify (e.g., reverse) the polarity of a term identified from the polar vocabulary 48.

The parser 44 may provide this functionality by applying a set of rules, called a grammar, dedicated to a particular natural language such as French, English, or Japanese. The grammar is written in a formal rule language, and describes the word or phrase configurations that the parser tries to recognize. The basic rule set used to parse basic documents in French, English, or Japanese is called the “core grammar.” Through use of a graphical user interface, a grammarian can create new rules to add to such a core grammar. In some embodiments, the syntactic parser employs a variety of parsing techniques known as robust parsing, as disclosed for example in Salah Aït-Mokhtar, Jean-Pierre Chanod, and Claude Roux, “Robustness beyond shallowness: incremental dependency parsing,” in special issue of the NLE Journal (2002); above-mentioned U.S. Pat. No. 7,058,567; and Caroline Brun and Caroline Hagège, “Normalization and paraphrasing using symbolic methods” ACL: Second International workshop on Paraphrasing, Paraphrase Acquisition and Applications, Sapporo, Japan, Jul. 7-12, 2003. In one embodiment, the syntactic parser 44 may be based on the Xerox Incremental Parser (XIP), which may have been enriched with additional processing rules to facilitate the extraction of nouns and adjectival terms associated with these. Other natural language processing or parsing algorithms can alternatively be used.

### Hashtag Opinion Extraction (S112)

In order to integrate hashtag polarity information into the opinion detection component/system 54, the opinion extraction component 42 operates on the list of decomposed hashtags which may have been preprocessed by the parser, as described in step S110. In one embodiment, the sentiment analysis component 46, which may be incorporated into the parser 44 by addition of rules, extracts opinion dependencies. Exemplary opinion dependencies are encoded in the following format:

OPINION[POLARITY](POLAR-PREDICATE, OPINION-TARGET)

where OPINION is the name of the semantic dependency, POLARITY is a feature associated with the dependency, which values can be “POSITIVE” or “NEGATIVE”, POLAR-PREDICATE is the opinionated term (word or expression) carrying the polarity of the opinion and OPINION-TARGET is the target of the opinion e.g., a noun or noun phrase which is in a semantic dependency with the polar predicate.

Examples of such opinion relations generated on an actual corpus of micro-blogs written in French are as follows:

### Example 1

#SarkoDegage (#SarkoClearOff): decomposition = “Sarko Degage”
“Sarko Degage”: dependency analysis result = SUBJ(Sarkozy, dégager)
OPINION[negative](dégager,Sarkozy)

In this example, the parser uses the normalization component to match “Degage” to its lemmatized form “dégager” and “Sarko” to its lemmatized form “Sarkozy.” The sentiment analysis component 46 then extracts a negative opinion relation associating the polar predicate “dégager” to its target, “Sarkozy”.

### Example 2

#cestridicule (#It's Ridiculous): decomposition = “c est ridicule”
“c est ridicule”: dependency analysis result = OBJ[PRED](est,ridicule)
OPINION[negative](ridicule,_UNKNOWN-TARGET)

In this second example the sentiment analysis component 46 detects a negative sentiment whose predicates is “ridicule”, the target remaining unspecified in this case.

The extracted information is output to the lexicon generator.

### Generating a Hashtag Lexicon (S114)

Once the opinion-related information is extracted from the hashtags, a dedicated hashtag lexicon 52 associating the hashtags with their semantic features (polarity and/or target, e.g., a proper name), can be generated. For example, for the following hashtags where the names of two politicians, “Smith,” and “Doe” are recognized as proper names:

#Smithwehateyou: noun +=[negative=+,target=“Smith”].
#VoteDoe: noun += [positive=+,target=“Doe”].
#Removethem: noun += [negative=+].
#GeorgeSmith”: noun +=[proper=+,person=+].

In the first case, for example, the entire hashtag is treated as a noun (as is always the case for hash tags), its polarity is negative, and the target is Smith. In the second case, the opinion rules specify that “vote” is a positive polar term, when associated with a proper name of type person, which is the case here. In the third case, the hashtag is given negative polarity, but there is no identified target that is a proper name. The fourth is recognized as an identifiable target which is a proper name, but the hashtag has no polarity.

Hashtags can be categorized in three types:
1. Topic hashtags, used to annotate a set of coarse topics, e.g., #Mr. N. Smith, #Election
2. Sentiment hashtags, e.g., #Idiot, #Disappointment . . .
3. Sentiment-Topic hashtags, that capture both sentiment and a target topic, e.g., #LongliveSmith, #DoeWeLoveYou . . .

As can be seen from these illustrative examples, some of the hashtags may have no identified polarity or no specific target, but may be stored in the hashtag lexicon 52 along with those that do, for example, for computing a total number of hashtags relating a given topic. In other embodiments, the hashtag lexicon may be limited to one or more of the three types, such as Sentiment-Topic hashtags which include both a sentiment (opinion) and a target which is in a syntactic relation with the word(s) conveying the opinion. In addition to the polarity, the hashtag may be associated with other information, such as the time(s) 20 at which it was used, extracted from the micro-blog(s) in which it was used. This allows for temporally-constrained queries to return information limited to a predefined time frame. The hashtag lexicon 52 may also store the number of occurrences of each stored hashtag.

### Opinion Detection (S118)

The hashtag lexicon 52 can be integrated as a resource in the opinion detection component 54. For example, the hashtags are considered as known words carrying semantic information, useful to extract relations of opinions. In one embodiment, the hashtag lexicon can be used on its own to assign polarity to a micro-blog 12, i.e., considering only the hashtag(s) 26 used in a micro-blog (in terms of their polarity and targets, where identified), without considering any of the surrounding text 24. One of the basic tasks in opinion mining or sentiment mining is classifying the polarity of a given text or feature/aspect level to find out whether it is positive, negative or neutral. Different methodologies have been used for this purpose. Some expert analysts use the scaling system to associate numbers with appropriate sentiments that a word is depicting. Subjectivity or objectivity identification can also achieve the purpose. However a more fine-grained analysis model for this purpose is the feature or aspect based sentiment mining method.

Feature based sentiment mining is used to determine the sentiments or opinions that are expressed on different features (aspects) of entities. When a text is classified at the document or sentence level, it may not identify what the opinion holder likes or dislikes. If a document is positive about an object, it does not mean that the opinion holder necessarily holds positive opinions about all the features of the object. Similarly if a document is negative, it does not mean that the opinion holder dislikes everything about the described object.

An exemplary system for performing feature-based opinion mining in which the hashtag lexicon may be utilized is described in above-mentioned U.S. Pub. No. 20120245923, and in Caroline Brun, “Detecting Opinions Using Deep Syntactic Analysis,” Proc. Recent Advances in Natural Language Processing (RANLP), pp. 392-398 (Sep. 12-14, 2011), and Pedro Filho, et al., “A Graphical User Interface for Feature-Based Opinion Mining,” Proc. NAACL-HLT 2012: Demonstration Session, pages 5-8 (Jun. 3-8, 2012). The opinion detection system 54 is designed on top of a robust syntactic parser (such as the Xerox Incremental Parser (XIP) see, U.S. Pat. No. 7,058,567; and Salah Aït-Mokthar, Jean-Pierre Chanod, and Claude Roux, “Robustness beyond Shallowness: Incremental Dependency Parsing,” Special Issue of NLE Journal (2002). The system described in these references, referred to herein as the “feature-based opinion detection system,” extracts deep syntactic dependencies, which as described above, are an intermediary step of the extraction of semantic relations of opinion. The system uses a polar vocabulary combined with syntactic dependencies extracted by the XIP parser into opinion relation extraction rules.

The exemplary system has a variety of applications including classification of tweets, extracting opinions about a topic, and the like. For example, a politician may be able to quickly identify which campaign advertisements were successful by analyzing the overall polarity of the hashtags which make reference to the politician or some aspect of his or her advertisement. Similarly, bloggers may comment on a new movie or product and the producer may be able to adjust the advertisements about the movie or product to address a negative response.

Without intending to limit the scope of the exemplary embodiment, the following examples demonstrate application of the system and method to a corpus of micro-blog.

### Examples

A corpus made available in the context of the Imagiweb French government funded project was used. This project has the goal of studying the image of entities of various kinds (e.g., company, brand, and politician), as it is disseminated and viewed on the Internet. Using the Imagiweb data, comments posted on Twitter about political entities may be analyzed with a view to performing automatic opinion analysis on these tweets.

In this example, the image of French politicians through Twitter, in the context of the French election in May 2012 was evaluated. A first dataset was used that is dedicated to the image of the two main candidates at that time: which are referred to herein as John Smith and Paul Doe for convenience of illustration. Imagiweb provides a collection of 3920 annotated tweets about the two politicians, which have been manually annotated regarding their polarity and targets. The complete corpus contains about 20,000 tweets.

The method described above was used to extract a list of 896 valid decomposed hashtags. Since the detection of a hashtag in a message is straightforward, as they all start with the hash sign “#,” the system had no difficulty in detecting hashtags. Precision was computed when hashtag candidates where split. The system gave about 80% precision for the 1132 different hashtags extracted from of 20,000 original tweets. For computing recall, the split is considered to be a fail when a hashtag was decomposed when it should not have been or into a set of words that was plainly incorrect. The process failed most often over acronyms (10% of all failed), foreign words (about 10% of all failed), and misspelled or unknown words (80% of all failed). At the end of the evaluation process 896 hashtag decompositions were validated.

Using the exemplary method, the validated decomposed tweets were annotated with a polarity together with the target of the opinion (such as physical appearance, political project, ethics, etc.).

Of the 896 hashtags, 215 hashtags encode both polarity and target (loosely translated to English for illustration), as in “#VoteDoe”, “#ShameDoe”, #SmithRubbish” and “#”SmithWeLoveYou. 304 hashtags encode only polarity, such as “#Moron” and “#Retard”, and 377 hashtags encode only topics, among which 169 are named entities.

Once this information was extracted from the hashtags, a dedicated hashtag lexicon 52 was automatically created in which the hashtags were associated with their semantic features (polarity and target when present, or named entity), for example (loosely translated to English):

#SmithLiar”: noun += [negative=+, target=“Smith”]
#VoteDoe” : noun += [positive=+, target=“Doe”]
“#BreakYourself” : noun += [negative=+].
“#JohnSmith” : noun +=[proper=+,person=+].

The hashtag lexicon 52 was integrated as a resource in a separate opinion detection system 54. The opinion detection system 54 considers the stored hashtags as known words, carrying semantic information, useful for extracting opinion relations.

In order to evaluate the impact of the integration of hashtag polarity and targets into the opinion extraction system, several classification experiments were performed on the Imagiweb corpus of 3920 annotated tweets. In these 3920 tweets, 392 different decomposed hashtags are presents.

An example of an annotated tweet which could have been found in this corpus (loosely translated and simplified for convenience), is as follows:

<annotatedtweet>
<id>135</id><image-of>Smith</image-
of><twitter>Languedeuxpute</twitter>
<date>20/04/2012</date>
<tweet> You have the truth about X and Y? RT
@JohnSmith “Vote extreme = extreme measures.
Extreme measures = lies.” </tweet>
<annotator>Z</annotator><target>Ethics</target>
<sub-target>Business</sub-target>
<polarity>−1/polarity><confidence>1/confidence>
</annotatedtweet>

In this illustrative example, the annotator has identified a target “ethics” and a sub target “business” of the tweet. The polarity assigned to the tweet is −1 (i.e., negative) and the confidence 1 (high confidence). No hashtag is employed in this example.

The performance measure used for evaluating an opinion detection system is the accuracy of classification. In order to evaluate the impact of hashtag polarity on the performance of an opinion detection system, the application of the system to the tweet polarity classification task was evaluated, with and without taking hashtag polarity into account. The results of the opinion detection, in different configurations, were used to train a support vector machine (SVM) binary classifier (SVMLight, described in Joachims, T. “Making large-Scale SVM Learning Practical. Advances in Kernel Methods—Support Vector Learning, B. Schölkopf and C. Burges and A. Smola (eds), MIT Press, 1999) in order to classify the reviews as positive or negative. For the different configurations of the system, the classification was performed on the same set of training/test data randomly extracted from the initial tweet corpus, and the performance results calculated with a ten-fold cross validation procedure. The test set consisted of 10% of the initial corpus and the training set of the remaining 90%, both sets having the same distribution of positive and negative tweets.

Configuration 1 (baseline system) uses a simple bag of words (BOW) approach to perform the classification.

Configuration 2 (hashtag only) integrates the hashtags together with their polarity (extracted from the lexicon 52) as a feature in the classification.

Configuration 3 (opinion relations only) integrates the opinion relations detected by the feature-based opinion detection system described above, without considering hashtags.

Configuration 4 (opinion+hashtag) integrates both opinion relations extracted by the feature-based opinion detection system and hashtag polarity (extracted from the lexicon 52).

The average accuracy of the cross validation results was estimated with the mean squared error measure. The following table summarizes the results for the 4 configurations.

TABLE 1

| EXPERIMENT | ACCURACY |
|---|---|
| 1: Baseline (BOW) | 80.1 |
| 2: hashtag only | 82.6 |
| 3: opinion relations only | 80.2 |
| 4: opinion + hashtag | 82.2 |

While the use of opinion relations as a feature for classification was not found to be an improvement over a bag of words representation on the corpus of tweets, the use of hashtags and their polarity improve the classification accuracy by about 2.5% over the bag of words representation. Adding opinion relations (extracted from the tweet as a whole) to the hashtag polarity did not yield a significant benefit on this small corpus.

The same experiments were run on a sub-corpus of the initial one, in which all tweets contain at least one hashtag. Of the 3912 initial tweets, only 1814 contain at least one hashtag. The results of the classification experiments are shown on the table below:

TABLE 2

| EXPERIMENT | ACCURACY |
|---|---|
| 1: Baseline (BOW) | 79.9 |
| 2: hashtag only | 84.6 |
| 3: opinion relations only | 80.1 |
| 4: opinion + hashtag | 84.7 |

In this case, the improvement on the classification task of over 4% over the BOW baseline was achieved when hashtags were used. These results confirm that integrating polarity and targets of hashtags have a positive impact on tweet polarity classification, particularly when hashtags are present. The results also suggest that using hashtag polarity is as good a predictor of tweet polarity as the combination of opinion relations with hashtag polarity. As will be appreciated, further improvements in the system could be achieved by training the feature-based opinion detection system on a corpus of micro-blogs of interest (the opinion-relations had been developed for particular use in classification of customer reviews).

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for processing micro-blogs, comprising:
for each of a set of hashtags extracted from a collection of micro-blogs:
decomposing the hashtag to generate a sequence of words;
natural language processing the decomposed hashtag with rules configured for identifying opinion dependencies linking polar terms with targets of the polar terms in the decomposed hashtag;
applying opinion detection rules to dependencies identified by the natural language processing, the opinion detection rules being configured for extracting opinion information from decomposed hashtags; and
storing at least some of the hashtags in the set of hashtags in a hashtag lexicon, the stored hashtags being associated with the extracted opinion information,
wherein at least one of the decomposing, natural language processing, applying opinion detection rules and storing of the hashtags is performed with a computer processor.

2. The method of claim 1, wherein the decomposing of the hashtag comprises providing for splitting the hashtag based on uppercase letters identified within the hashtag.

3. The method of claim 1, wherein the decomposing of the hashtag comprises starting at a first end of the hashtag, searching for the longest sequence of characters, starting with the first character, which is recognized in a predefined word lexicon, splitting the hashtag at the end of the longest recognizable sequence of characters, and repeating the searching, starting with the next character after the longest sequence, until no more characters remain to be searched.

4. The method of claim 3, wherein the decomposing of the hashtag further comprises starting at a second end of the hashtag, searching for the longest sequence of characters, starting with the first character, which is recognized in a predefined word lexicon, splitting the hashtag at the end of the longest recognizable sequence of characters, and repeating the searching, starting with the next character after the longest sequence, until no more characters remain to be searched.

5. The method of claim 1, wherein where the decomposing of the hashtag generates more than one candidate sequence of words, identifying an optimal one of the candidate sequences.

6. The method of claim 1, wherein the natural language processing includes accessing a polar vocabulary which stores a set of terms, each with an associated polarity, to identify terms in the detected opinion dependencies which are found in the polar vocabulary and associating a polarity with the dependency based on a polarity of a term found in the polar vocabulary.

7. The method of claim 6, wherein when an identified opinion dependency includes an identifiable target, the method includes associating a polarity with the identifiable target based on the polarity associated with a polar term in the opinion dependency with the target.

8. The method of claim 1, wherein the identified dependencies include at least one of:
TARGET-PREDICATE dependencies and wherein the polar vocabulary includes a set of polar verbs; and
TARGET-ADJECTIVE dependencies and wherein the polar vocabulary includes polar adjectives.

9. The method of claim 1, wherein the method further comprises receiving a request for an opinion on a topic and computing an opinion for the topic comprising accessing the hashtag lexicon to identify opinion information associated with hashtags related to the requested topic and computing the opinion for the topic based on the identified opinion information.

10. The method of claim 1 wherein the hashtag lexicon includes hashtags categorized by type, the types including:
topic hashtags, which are hashtags which include one of a set of predefined topics but which do not carry an opinion,
sentiment hashtags, which carry an opinion which is not related to one of a set of predefined topics, and
sentiment-topic hashtags, that carry an opinion and a topic which is a target.

11. The method of claim 1, wherein the method further comprises, for a new micro-blog to be evaluated which includes at least one hashtag, accessing the lexicon and associating opinion information with those of the hashtags in the new micro-blog that are found in the lexicon.

12. The method of claim 11, further comprising outputting opinion information for the micro-blog based on the opinion information associated with the at least one hashtag.

13. The method of claim 12, wherein each of the hashtags in the hashtag lexicon is treated as a noun.

14. A computer program product comprising a non-transitory recording medium storing instructions, which when executed on a computer causes the computer to perform the method of claim 1.

15. A micro-blog processing system comprising memory which stores instructions for performing the method of claim 1 and a processor in communication with the memory for executing the instructions.

16. A micro-blog processing system comprising:
an extraction component configured for extracting hashtags from a micro-blog;
a decomposition component for decomposing an extracted hashtag to generate a sequence of words;
a parser for natural language processing the decomposed hashtag with rules configured for identifying opinion dependencies linking targets with polar terms in the decomposed hashtag;
a sentiment analysis component for applying opinion detection rules to the opinion dependencies identified by the natural language processing to extract and output opinion information for the hashtag, based on the application of the rules; and
a processor which implements the extraction component, decomposition component, parser, and sentiment analysis component.

17. The system of claim 16, wherein the micro-blog comprises a collection of micro-blogs and the system further comprises a lexicon generator which stores at least some of the hashtags extracted from the collection of micro-blogs in a hashtag lexicon, the hashtags being associated in the hashtag lexicon with the extracted opinion information.

18. The system of claim 16, further comprising an opinion detection component which outputs an opinion on a topic based on opinion information of hashtags in the lexicon which refer to the topic.

19. The system of claim 16, further comprising a polar vocabulary accessible to the sentiment analysis component, which stores a set of the polar terms, each of the polar terms being associated with a respective polarity.

20. The system of claim 19, wherein some of the polar terms in the lexicon are assigned a negative polarity and some of the polar terms are assigned a positive polarity.

21. An opinion extraction system comprising:
memory which stores a lexicon of hashtags in which at least some of the hashtags are each associated with opinion information comprising a polarity and a target of the opinion, the opinion information having been extracted by automatically decomposing and natural language processing the hashtag;
an opinion detection component configured for receiving a query related to a topic and for aggregating opinion information of the hashtags in the lexicon for which the respective target is relevant to the topic; and
a processor which implements the opinion detection component.
